(19) United States
(12) Patent Application Publication
(10) Pub. No.: US 2025/0111127 A1
(43) Pub. Date: Apr. 3, 2025

(54) SYSTEMS AND METHODS FOR IMPROVING DOCUMENT READABILITY

(71) Applicant: JPMORGAN CHASE BANK, N.A., New York, NY (US)

(72) Inventors: John JONES, Hastings-on-Hudson, NY (US); Karin LANE, Sleepy Hollow, NY (US); Nathan-Daniel MILLAR, Glasgow (GB)

(21) Appl. No.: 18/478,389

(22) Filed: Sep. 29, 2023

(51) Int. Cl. G06F 40/109; G06F 40/279

(52) U.S. Cl. CPC G06F 40/109; G06F 40/279

(57) ABSTRACT

Systems and methods for improving document readability are disclosed. A method may include: (1) receiving, by a computer program executed on a user electronic device, may receive a document comprising text; (2) identifying, the computer program, a subject for the document; (3) retrieving, by the computer program, a plurality of trigger words and a plurality of skim-through words for the subject; (4) identifying, by the computer program, trigger words in the text of the document and applying a first graphical pattern to the identified trigger words; (5) identifying, by the computer program, skim-through words in the text of the document and applying a second graphical pattern to the identified skim-through words; and (6) causing, by the computer program, the document to be output with the identified trigger words output in the first graphical pattern and the skim-through words being output in the second graphical pattern.

### BACKGROUND OF THE INVENTION

### 1. Field of the Invention

Embodiments relate to systems and methods for improving document readability.

### 2. Description of the Related Art

Reading complex documents, such as industry research, web pages, user stories, complex emails, complex user interfaces, etc., takes a long time. One of the largest issues across any industry with complex research is finding a way to absorb, scan, and retain the documents and text. Wading through the complexity of the text creates mental fatigue and a great deal of lost time and meaning.

### SUMMARY OF THE INVENTION

Systems and methods for improving document readability are disclosed. According to one embodiment, a method for improving document readability may include: (1) receiving, by a computer program executed on a user electronic device may receive a document comprising text; (2) identifying, the computer program, a subject for the document; (3) retrieving, by the computer program, a plurality of trigger words and a plurality of skim-through words for the subject; (4) identifying, by the computer program, trigger words in the text of the document and applying a first graphical pattern to the identified trigger words; (5) identifying, by the computer program, skim-through words in the text of the document and applying a second graphical pattern to the identified skim-through words; and (6) causing, by the computer program, the document to be output with the identified trigger words output in the first graphical pattern and the skim-through words being output in the second graphical pattern.

In one embodiment, the step of identifying the subject for the document may include: providing, by the computer program, the text of the document to a large language model; and receiving, by the computer program, the subject from the large language model.

In one embodiment, the first graphical pattern visually brings the identified trigger words to a foreground of the document.

In one embodiment, the first graphical pattern may include a high-contrast color.

In one embodiment, the first graphical pattern may include an increased font size.

In one embodiment, the second graphical pattern visually brings the identified skim-through words to a background of the document.

In one embodiment, the second graphical pattern may include a low-contrast color.

In one embodiment, the second graphical pattern may include a decreased font size.

In one embodiment, words in the text that are not identified trigger words or identified skim-through words are output in a third graphical pattern, wherein the third graphical pattern may be a neutral graphical pattern.

In one embodiment, the method may also include: determining, by the computer program, that a percentage of trigger words in at least a portion of the document is below a threshold; and causing, by the computer program, the document to be output with no changes.

According to another embodiment, a system may include: a trigger word database comprising a plurality of trigger words; a skim-through database comprising a plurality of skim-through words; and an electronic device comprising: a display; a computer processor; and a memory storing a document readability computer program comprising instructions that, when executed by the computer processor, causes the computer processor to receive a document comprising text; identify a subject for the document; retrieve trigger words from the trigger word database and skim-through words from the skim-through word database for the subject; identify trigger words in the text of the document and apply a first graphical pattern to the identified trigger words; identify skim-through words in the text of the document and apply a second graphical pattern to the identified skim-through words; and cause the document to be output with the identified trigger words output in the first graphical pattern and the skim-through words being output in the second graphical pattern on the display.

In one embodiment, the subject for the document may be identified by providing the text of the document to a large language model and receiving the subject from the large language model.

In one embodiment, the first graphical pattern visually brings the identified trigger words to a foreground of the document.

In one embodiment, the first graphical pattern may include a high-contrast color.

In one embodiment, the first graphical pattern may include an increased font size.

In one embodiment, the second graphical pattern visually brings the identified skim-through words to a background of the document.

In one embodiment, the second graphical pattern may include a low-contrast color.

In one embodiment, the second graphical pattern may include a decreased font size.

In one embodiment, words in the text that are not identified trigger words or identified skim-through words are output in a third graphical pattern, wherein the third graphical pattern may be a neutral graphical pattern.

In one embodiment, the document readability computer program may also include instructions that, when executed by the computer processor, causes the computer processor to determine that a percentage of trigger words in at least a portion of the document is below a threshold and to cause the document to be output with no changes.

### BRIEF DESCRIPTION OF THE DRAWINGS

For a more complete understanding of the present invention, the objects and advantages thereof, reference is now made to the following descriptions taken in connection with the accompanying drawings in which:

FIG. 1 illustrates a system for improving document readability according to an embodiment;

FIG. 2 illustrates a method for improving document readability according to an embodiment; and

FIG. 3 depicts an exemplary computing system for implementing aspects of the present disclosure.

### DETAILED DESCRIPTION OF PREFERRED EMBODIMENTS

Embodiments relate to systems and methods for improving document readability.

Embodiments may process documents into a format that creates scannable emphasis layers in the text. For example, a three color system may be applied to the words in the text—“skim-through” words, such as prepositions, may be “pushed” into the background by using a low contrast color, such as gray, trigger words may be “pulled” into the foreground using a high contrast color, such as blue, and the remaining text—the core words—may be maintained in a neutral color, such as black.

The trigger words may describe specific actions that the reader may want to take on the information provided. The trigger word in each sentence often anchors the important meaning and allows the reader to quickly scan for the action or object they are most interested in.

The neutral blocks of text with no intended action, such as the skim-through words and the core words—are displayed in gray and blue.

The three “layers” create a word system that is easily scannable by expert readers, and creates an easier entry for new or novice readers.

Embodiments may classify documents into a subject by providing the skim-through words and the trigger words into a large language model (LLM). Classifying the documents into research, news, technical instructions, and other categories allows for the further refinement of the trigger word lists, as triggering actions may change depending on the subject for the document. For example, in financial services, the trigger words may be connected to market movements, whereas in technical documentation, the trigger words may be linked to specific instructions for the user to take, such as “login,” “copy,” “download,” etc.

Examples of documents include complex documents, such as industry research, web pages, user stories, and complex emails; complex user interfaces; customer call transcripts and logs, etc.

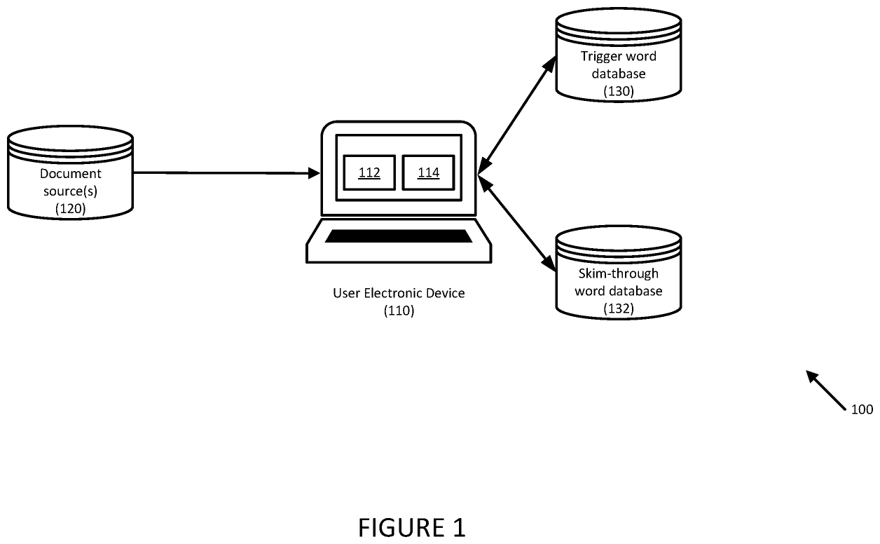

Referring to FIG. 1, a system for improving document readability is disclosed according to an embodiment. System 100 may include user electronic device 110, which may be any suitable electronic device, including computers (e.g., workstations, desktops, laptops, tablets, etc.), smart devices (e.g., smart phones, smart watches, etc.), IoT appliances, etc. User electronic device 110 may execute computer program 112, which may be a document program, such as a word processing program, a document viewer, a web browser, etc., that may access a document in document source 120. The document may be a word processing document, a PDF, a webpage, an email, etc.

Document source 120 may be any suitable document source, including document libraries, document repositories, websites, email servers, etc. The documents from document source 120 may be in any format, including emails, webpages, pdfs, word processing documents, etc.

User electronic device may also execute document readability computer program 114 that may interface with computer program 112. In one embodiment, document readability computer program 114 may be integrated into computer program 112 as an add-on, as a script, etc.

In one embodiment, document readability computer program 114 may be executed in the cloud, on a server, etc. and may be accessed by computer program 112.

System 100 may further include trigger word database 130 and skim-through word database 132. The contents of trigger word database 130 and skim-through word database 132 may be populated by subject matter experts, using machine learning, etc. In one embodiment, each subject for a document may have a different set of trigger words and/or skim-through words. Thus, document readability computer program 114 may access the appropriate trigger words and/or skim-through words for the subject of the document.

In one embodiment, document readability computer program 114 may identify the subject for the document using a large language model (not shown). For example, document readability computer program 114 may provide the text of the document to a large language model that may return an identification of the subject for the document.

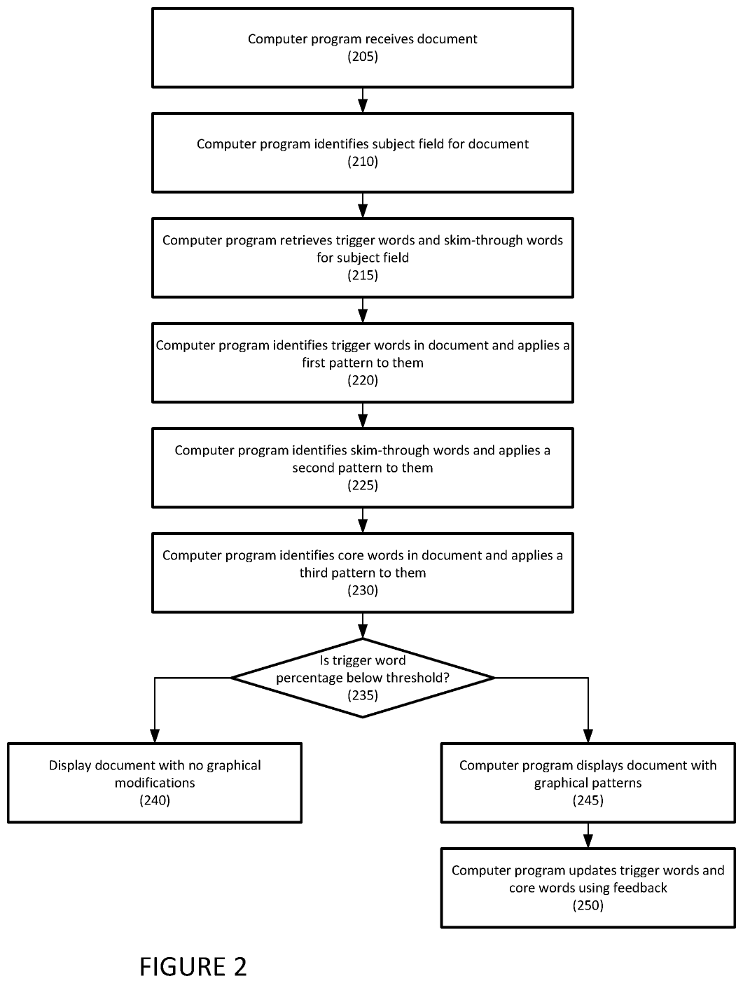

Referring to FIG. 2, a method for improving document readability is disclosed according to an embodiment.

In step 205, a computer program, such as a document readability computer program executed on a user electronic device may receive a document that includes text. The document may be a word processing document, a portable document format (PDF) document, a web document, an email, etc. Any suitable type of document may be received as is necessary and/or desired.

In step 210, the computer program may identify a subject for the document. For example, the computer program may provide the text of the document to a large language model, which may identify a subject, such as an industry, for the text in the document.

In step 215, the computer program may retrieve a library of trigger words and skim-through words that are associated with the subject.

In step 220, the computer program may identify trigger words in the text and may apply a first graphical pattern to them. For example, the trigger words may be associated with a graphical pattern that causes them to move into the foreground. An example of such a graphical pattern is a high-contrast color, such as blue. Other graphical patterns, such as an increased font size, a different font, bolding, etc. that causes the trigger words to visually move into the foreground may be used as is necessary and/or desired.

In one embodiment, the computer program may limit the number of trigger words in a paragraph, a document, etc. For example, a maximum value (e.g., 50%) of the words in a paragraph, document, etc. may be applied so that the highlighting of the trigger words does not lose its impact. If more than the maximum value of words in a paragraph, document, etc. are identified as trigger words, the computer program may selectively de-identify certain words as trigger words. The de-identification may be based on proximity of the trigger words, such as no more than consecutive three trigger words, no more than three trigger words out of five words, etc.

The maximum value may be set by the user, may be based on machine learning, etc.

In step 225, the computer program may identify the skim-through words in the text and may apply a second graphical pattern to them. For example, the skim-through words may be associated with a graphical pattern that causes them to visually fade into the background. An example of such a graphical pattern is a low contrast color, such as grey. Other graphical patterns, such as a reduced font size, a different font, etc. that causes the skim-through words to visually fade into the background may be used as is necessary and/or desired.

In step 230, the computer program may identify core words in the text and may apply a third graphical pattern to them. The core words may be any words remaining after the trigger words and pass-through words are identified. For example, the core words may be associated with a graphical pattern that causes them to remain neutral. An example of such a graphical pattern is a neutral color, such as black.

In one embodiment, the graphical properties of the core words may be unchanged.

It should be noted that the graphical patterns above presume a white background. Different graphical patterns, colors, fonts, font sizes, etc. may be used in response to different backgrounds as is necessary and/or desired.

In one embodiment, the reader may customize the graphical patterns as is necessary and/or desired. For example, if a user finds that a red graphical pattern is better than a blue graphical pattern, the user may update the second graphical pattern to better suit the reader's needs.

In step 235, the computer program may determine a percentage of trigger words in the document or a portion of the document, and may compare it to a threshold. For example, the computer program may compare the number of trigger words to the total number of words in the document, or the number of trigger words in a portion of the document to the total number of words in the portion of the document.

If the percentage of trigger words in the document, or in portions of the document, is low (e.g., close to 0%), this indicates a neutral document, with no action intended or implied for the user. Thus, in step 240, the document may be presented without any graphical modifications.

If the percentage of trigger words in the document, or in portions of the document, is above the threshold, in step 245, the computer program may display the document with the text displayed according to the graphical patterns. For example, the computer program may display the document on a screen.

In another embodiment, the computer program may cause the document to be printed with the text according to the graphical patterns.

In step 250, the computer program may receive reader feedback and may update the trigger words and/or skim-through words using the feedback. For example, the reader may identify words that were not identified as trigger words or skim-through words. The reader may submit the feedback to the computer program in any suitable manner. The updated trigger words and/or skim-through words may be used to process the next document.

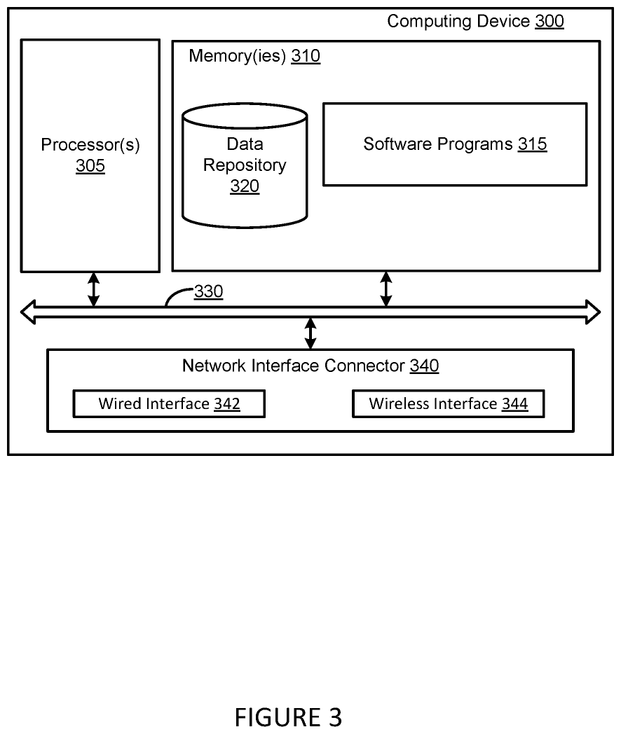

FIG. 3 depicts an exemplary computing system for implementing aspects of the present disclosure. FIG. 3 depicts exemplary computing device 300. Computing device 300 may represent the system components described herein. Computing device 300 may include processor 305 that may be coupled to memory 310. Memory 310 may include volatile memory. Processor 305 may execute computer-executable program code stored in memory 310, such as software programs 315. Software programs 315 may include one or more of the logical steps disclosed herein as a programmatic instruction, which may be executed by processor 305. Memory 310 may also include data repository 320, which may be nonvolatile memory for data persistence. Processor 305 and memory 310 may be coupled by bus 330. Bus 330 may also be coupled to one or more network interface connectors 340, such as wired network interface 342 or wireless network interface 344. Computing device 300 may also have user interface components, such as a screen for displaying graphical user interfaces and receiving input from the user, a mouse, a keyboard and/or other input/output components (not shown).

Hereinafter, general aspects of implementation of the systems and methods of embodiments will be described.

Embodiments of the system or portions of the system may be in the form of a “processing machine,” such as a general-purpose computer, for example. As used herein, the term “processing machine” is to be understood to include at least one processor that uses at least one memory. The at least one memory stores a set of instructions. The instructions may be either permanently or temporarily stored in the memory or memories of the processing machine. The processor executes the instructions that are stored in the memory or memories in order to process data. The set of instructions may include various instructions that perform a particular task or tasks, such as those tasks described above. Such a set of instructions for performing a particular task may be characterized as a program, software program, or simply software.

In one embodiment, the processing machine may be a specialized processor.

In one embodiment, the processing machine may be a cloud-based processing machine, a physical processing machine, or combinations thereof.

As noted above, the processing machine executes the instructions that are stored in the memory or memories to process data. This processing of data may be in response to commands by a user or users of the processing machine, in response to previous processing, in response to a request by another processing machine and/or any other input, for example.

As noted above, the processing machine used to implement embodiments may be a general-purpose computer. However, the processing machine described above may also utilize any of a wide variety of other technologies including a special purpose computer, a computer system including, for example, a microcomputer, mini-computer or mainframe, a programmed microprocessor, a micro-controller, a peripheral integrated circuit element, a CSIC (Customer Specific Integrated Circuit) or ASIC (Application Specific Integrated Circuit) or other integrated circuit, a logic circuit, a digital signal processor, a programmable logic device such as a FPGA (Field-Programmable Gate Array), PLD (Programmable Logic Device), PLA (Programmable Logic Array), or PAL (Programmable Array Logic), or any other device or arrangement of devices that is capable of implementing the steps of the processes disclosed herein.

The processing machine used to implement embodiments may utilize a suitable operating system.

It is appreciated that in order to practice the method of the embodiments as described above, it is not necessary that the processors and/or the memories of the processing machine be physically located in the same geographical place. That is, each of the processors and the memories used by the processing machine may be located in geographically distinct locations and connected so as to communicate in any suitable manner. Additionally, it is appreciated that each of the processor and/or the memory may be composed of different physical pieces of equipment. Accordingly, it is not necessary that the processor be one single piece of equipment in one location and that the memory be another single piece of equipment in another location. That is, it is contemplated that the processor may be two pieces of equipment in two different physical locations. The two distinct pieces of equipment may be connected in any suitable manner. Additionally, the memory may include two or more portions of memory in two or more physical locations.

To explain further, processing, as described above, is performed by various components and various memories. However, it is appreciated that the processing performed by two distinct components as described above, in accordance with a further embodiment, may be performed by a single component. Further, the processing performed by one distinct component as described above may be performed by two distinct components.

In a similar manner, the memory storage performed by two distinct memory portions as described above, in accordance with a further embodiment, may be performed by a single memory portion. Further, the memory storage performed by one distinct memory portion as described above may be performed by two memory portions.

Further, various technologies may be used to provide communication between the various processors and/or memories, as well as to allow the processors and/or the memories to communicate with any other entity; i.e., so as to obtain further instructions or to access and use remote memory stores, for example. Such technologies used to provide such communication might include a network, the Internet, Intranet, Extranet, a LAN, an Ethernet, wireless communication via cell tower or satellite, or any client server system that provides communication, for example. Such communications technologies may use any suitable protocol such as TCP/IP, UDP, or OSI, for example.

As described above, a set of instructions may be used in the processing of embodiments. The set of instructions may be in the form of a program or software. The software may be in the form of system software or application software, for example. The software might also be in the form of a collection of separate programs, a program module within a larger program, or a portion of a program module, for example. The software used might also include modular programming in the form of object-oriented programming. The software tells the processing machine what to do with the data being processed.

Further, it is appreciated that the instructions or set of instructions used in the implementation and operation of embodiments may be in a suitable form such that the processing machine may read the instructions. For example, the instructions that form a program may be in the form of a suitable programming language, which is converted to machine language or object code to allow the processor or processors to read the instructions. That is, written lines of programming code or source code, in a particular programming language, are converted to machine language using a compiler, assembler or interpreter. The machine language is binary coded machine instructions that are specific to a particular type of processing machine, i.e., to a particular type of computer, for example. The computer understands the machine language.

Any suitable programming language may be used in accordance with the various embodiments. Also, the instructions and/or data used in the practice of embodiments may utilize any compression or encryption technique or algorithm, as may be desired. An encryption module might be used to encrypt data. Further, files or other data may be decrypted using a suitable decryption module, for example.

As described above, the embodiments may illustratively be embodied in the form of a processing machine, including a computer or computer system, for example, that includes at least one memory. It is to be appreciated that the set of instructions, i.e., the software for example, that enables the computer operating system to perform the operations described above may be contained on any of a wide variety of media or medium, as desired. Further, the data that is processed by the set of instructions might also be contained on any of a wide variety of media or medium. That is, the particular medium, i.e., the memory in the processing machine, utilized to hold the set of instructions and/or the data used in embodiments may take on any of a variety of physical forms or transmissions, for example. Illustratively, the medium may be in the form of a compact disc, a DVD, an integrated circuit, a hard disk, a floppy disk, an optical disc, a magnetic tape, a RAM, a ROM, a PROM, an EPROM, a wire, a cable, a fiber, a communications channel, a satellite transmission, a memory card, a SIM card, or other remote transmission, as well as any other medium or source of data that may be read by the processors.

Further, the memory or memories used in the processing machine that implements embodiments may be in any of a wide variety of forms to allow the memory to hold instructions, data, or other information, as is desired. Thus, the memory might be in the form of a database to hold data. The database might use any desired arrangement of files such as a flat file arrangement or a relational database arrangement, for example.

In the systems and methods, a variety of “user interfaces” may be utilized to allow a user to interface with the processing machine or machines that are used to implement embodiments. As used herein, a user interface includes any hardware, software, or combination of hardware and software used by the processing machine that allows a user to interact with the processing machine. A user interface may be in the form of a dialogue screen for example. A user interface may also include any of a mouse, touch screen, keyboard, keypad, voice reader, voice recognizer, dialogue screen, menu box, list, checkbox, toggle switch, a pushbutton or any other device that allows a user to receive information regarding the operation of the processing machine as it processes a set of instructions and/or provides the processing machine with information. Accordingly, the user interface is any device that provides communication between a user and a processing machine. The information provided by the user to the processing machine through the user interface may be in the form of a command, a selection of data, or some other input, for example.

As discussed above, a user interface is utilized by the processing machine that performs a set of instructions such that the processing machine processes data for a user. The user interface is typically used by the processing machine for interacting with a user either to convey information or receive information from the user. However, it should be appreciated that in accordance with some embodiments of the system and method, it is not necessary that a human user actually interact with a user interface used by the processing machine. Rather, it is also contemplated that the user interface might interact, i.e., convey and receive information, with another processing machine, rather than a human user. Accordingly, the other processing machine might be characterized as a user. Further, it is contemplated that a user interface utilized in the system and method may interact partially with another processing machine or processing machines, while also interacting partially with a human user.

It will be readily understood by those persons skilled in the art that embodiments are susceptible to broad utility and application. Many embodiments and adaptations of the present invention other than those herein described, as well as many variations, modifications and equivalent arrangements, will be apparent from or reasonably suggested by the foregoing description thereof, without departing from the substance or scope. Accordingly, while the embodiments of the present invention have been described here in detail in relation to its exemplary embodiments, it is to be understood that this disclosure is only illustrative and exemplary of the present invention and is made to provide an enabling disclosure of the invention. Accordingly, the foregoing disclosure is not intended to be construed or to limit the present invention or otherwise to exclude any other such embodiments, adaptations, variations, modifications or equivalent arrangements.

What is claimed is:

1. A method for improving document readability, comprising:
receiving, by a computer program executed on a user electronic device may receive a document comprising text;
identifying, the computer program, a subject for the document;
retrieving, by the computer program, a plurality of trigger words and a plurality of skim-through words for the subject;
identifying, by the computer program, trigger words in the text of the document and applying a first graphical pattern to the identified trigger words;
identifying, by the computer program, skim-through words in the text of the document and applying a second graphical pattern to the identified skim-through words; and
causing, by the computer program, the document to be output with the identified trigger words output in the first graphical pattern and the skim-through words being output in the second graphical pattern.

2. The method of claim 1, wherein the step of identifying the subject for the document comprises:
providing, by the computer program, the text of the document to a large language model; and
receiving, by the computer program, the subject from the large language model.

3. The method of claim 1, wherein the first graphical pattern visually brings the identified trigger words to a foreground of the document.

4. The method of claim 3, wherein the first graphical pattern comprises a high-contrast color.

5. The method of claim 3, wherein the first graphical pattern comprises an increased font size.

6. The method of claim 1, wherein the second graphical pattern visually brings the identified skim-through words to a background of the document.

7. The method of claim 6, wherein the second graphical pattern comprises a low-contrast color.

8. The method of claim 6, wherein the second graphical pattern comprises a decreased font size.

9. The method of claim 1, wherein words in the text that are not identified trigger words or identified skim-through words are output in a third graphical pattern, wherein the third graphical pattern is a neutral graphical pattern.

10. The method of claim 1, further comprising:
determining, by the computer program, that a percentage of trigger words in at least a portion of the document is below a threshold; and
causing, by the computer program, the document to be output with no changes.

11. A system, comprising:
a trigger word database comprising a plurality of trigger words;
a skim-through database comprising a plurality of skim-through words;
an electronic device comprising:
a display;
a computer processor;
and a memory storing a document readability computer program comprising instructions that, when executed by the computer processor, causes the computer processor to receive a document comprising text; identify a subject for the document; retrieve trigger words from the trigger word database and skim-through words from the skim-through word database for the subject; identify trigger words in the text of the document and apply a first graphical pattern to the identified trigger words; identify skim-through words in the text of the document and apply a second graphical pattern to the identified skim-through words; and cause the document to be output with the identified trigger words output in the first graphical pattern and the skim-through words being output in the second graphical pattern on the display.

12. The system of claim 11, wherein the subject for the document is identified by providing the text of the document to a large language model and receiving the subject from the large language model.

13. The system of claim 11, wherein the first graphical pattern visually brings the identified trigger words to a foreground of the document.

14. The system of claim 13, wherein the first graphical pattern comprises a high-contrast color.

15. The system of claim 13, wherein the first graphical pattern comprises an increased font size.

16. The system of claim 11, wherein the second graphical pattern visually brings the identified skim-through words to a background of the document.

17. The system of claim 16, wherein the second graphical pattern comprises a low-contrast color.

18. The system of claim 16, wherein the second graphical pattern comprises a decreased font size.

19. The system of claim 11, wherein words in the text that are not identified trigger words or identified skim-through words are output in a third graphical pattern, wherein the third graphical pattern is a neutral graphical pattern.

20. The system of claim 11, wherein the document readability computer program further comprises instructions that, when executed by the computer processor, causes the computer processor to determine that a percentage of trigger words in at least a portion of the document is below a threshold and to cause the document to be output with no changes.
